(19) United States
(12) Patent Application Publication
(10) Pub. No.: US 2026/0215398 A1
(43) Pub. Date: Jul. 30, 2026

(54) UNIVERSAL ANIMAL SLIP LEASH

(71) Applicant: ILANA KACZMAREK, TORONTO (CA)

(72) Inventor: ILANA KACZMAREK, TORONTO (CA)

(21) Appl. No.: 19/460,276

(22) Filed: Jan. 26, 2026

Related U.S. Application Data
(60) Provisional application No. 63/749,686, filed on Jan. 26, 2025.

(51) Int. Cl. A01K 27/00; A01K 25/00

(52) U.S. Cl. CPC A01K 27/003; A01K 25/00; A01K 27/002

(57) ABSTRACT

An animal slip leash that can be toggled between a snout loop configuration, a neck strap configuration, a torso band configuration, and a harness configuration. The slip leash is made of a flexible cord forming a handle at the proximal end held by an animal handler, and multiple openings configured at a distal end formed by a movable anchor that glides along the cord to custom fit different sized animals. The slip leash gives the handler enhanced control when walking the animal, and reduces leash reactivity and pulling in response to environmental stimuli.

### FIELD OF THE INVENTION

The present disclosure relates to a universal slip leash for dogs. More particularly to a slip leash that may be converted between multiple configurations, including a snout loop system, a neck strap system, a torso band system, and a harness system.

### BACKGROUND

Humans and dogs have had a special bond for thousands of years. Taking a dog for a walk is integral for strengthening this relationship, and an essential part of dog life. This enjoyable experience can become a nightmare for the human handler when the dog is a heavy puller, or when the dog is “leash reactive” and out of control, especially in a public setting. Numerous dog training devices have been used traditionally to help the handler gain control of their dog. Some of these devices are controversial in both their efficacy and appearance.

There remains a need for a dog training tool in the form of a slip leash, that has the ability to control dogs, and prevent them from pulling on the leash, while maintaining an aesthetically pleasing appearance in a “one size fits all” highly customizable and easily configurable way.

### SUMMARY OF THE INVENTION

The present disclosure describes a slip leash for animals.

In one aspect, for example, an animal slip leash includes a cord, a connector movable along the length of the cord, a cord lock at the distal end of the cord, and an anchor slidably adapted to secure the distal end of the cord to the animal.

Some implementations include one or more features. For example, in some cases, the slip leash includes a handle at the proximal end wherein the handle is adjustable. In some implementations, the handle comprises a snap hook that has the ability to open and clamp back to the cord, wherein the cord of the cord encircles an animal handler around the waist or chest, to custom fit the handler in a hands-free configuration. In some instances the snap hook can be used to encircle objects and tether them to the slip leash handle with ease.

In some implementations, the cord lock is spring-loaded when suppressed by the handler for disengaging and re-engaging the cord lock.

In some implementations, the connector comprises a ring or carabiner further comprising one or more of metal, plastic, wood, rubber, vinyl, polytetrafluoroethylene (PTFE), or silicone. In some cases, the connector comprises the form of the following letters: B, D, O, P, Q, S, or the form of the following shapes: triangle, circle, square, oval, rectangle, pentagon, hexagon, octagon, heart, star, diamond.

In some implementations, the anchor is adjustable to different locations along the length of the cord, to allow a custom fit around an animal's snout, neck or torso. In some cases, the anchor comprises a swivel with at least 2 adjacent apertures that receive the cord. In some instances, the apertures comprise of a solid frame. In some implementations, the anchor comprises a smooth surface that has a low coefficient of friction with the cord.

Some implementations include one or more of the following advantages: The slip leash is built with high-quality components, the leash has a strong construction that can endure harsh environments, the leash provides consistent performance, and the slip leash has an attractive appearance. In some instances, the slip leash allows for on-site adjustments by way of multi-function configurations and can be used by a wide range of dog handlers including: show dog handlers, sport dog handlers, service dog handlers, police dog handlers, search and rescue dog handlers, therapy dog handlers, and others.

Although particular examples are described in connection with a slip leash for dogs, the slip leashes described here also may be used for other animals.

The Slip leash may reduce the risk of escape or loss of control during sudden animal movements by enabling significant control with minimal physical effort, eliminating the need for high pressure tools such as prong collars. Its intuitive design makes it particularly useful for novice handlers to gain and maintain better control of their animals.

The details of one or more implementations are set forth in the accompanying drawings and the description below. Other aspects, features and advantages will be apparent from the following detailed description, the accompanying drawings, and the claims.

### BRIEF DESCRIPTIONS OF THE DRAWINGS

For a better understanding of the present invention, as well as other aspects and further features thereof, reference is made to the following description which is to be used in conjunction with the accompanying figures which illustrate embodiments or aspects of the invention, where:

FIG. 1A is a side view of the snout loop configuration of the slip leash in use with a dog;

FIG. 1B is a perspective view of the snout loop configuration of a slip leash;

FIG. 2 is a detailed close up view depicting the anchor component of the slip leash from FIG. 1B;

FIG. 3A is a side view of the neck strap configuration of the slip leash in use with a dog;

FIG. 3B is a perspective view of the neck strap configuration of the slip leash;

FIG. 4A is a side view of the torso band configuration of the slip leash in use with a dog;

FIG. 4B is a perspective view of the torso band configuration of the slip leash;

FIG. 5A is a side view of the harness configuration of the slip leash in use with a dog;

FIG. 5B is a perspective view of the harness configuration of the slip leash;

FIG. 6 is a perspective view of a handler wearing the slip leash across the body in a hands-free configuration.

### DETAILED DESCRIPTION OF THE INVENTION

The present disclosure describes a slip leash that can be used universally in many industries to help dog handlers train, walk and gain control of their dogs when they pull on the leash. The slip leash provides the ability to toggle easily between a snout loop system, neck strap system, torso band system and harness system with one easy to use leash eliminating the need for multiple tools. The slip leash is built with high-quality components, has a strong construction and an attractive appearance.

The present disclosure uses terminology such as “animal” and “dog”, and these words may be used interchangeably. A dog is shown herein as an example animal for the purpose of the present slip leash, however it is understood that the presently described slip leash invention may be used by any species of animal (e.g., dog, cat, raccoon, rabbit, horse, etc.) and any type of animal (wild animal, pet animal, zoo animal, etc.) while remaining within the scope of the present disclosure.

The length, size and/or configuration of the slip leash can vary according to the type, size and age of the animal intended to wear the slip leash. Further, the particular materials used to construct the slip leash, can be chosen according to the particular animal that is intended to wear the slip leash.

Throughout the following detailed description, examples of various slip leash configurations are provided. Related features and components in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

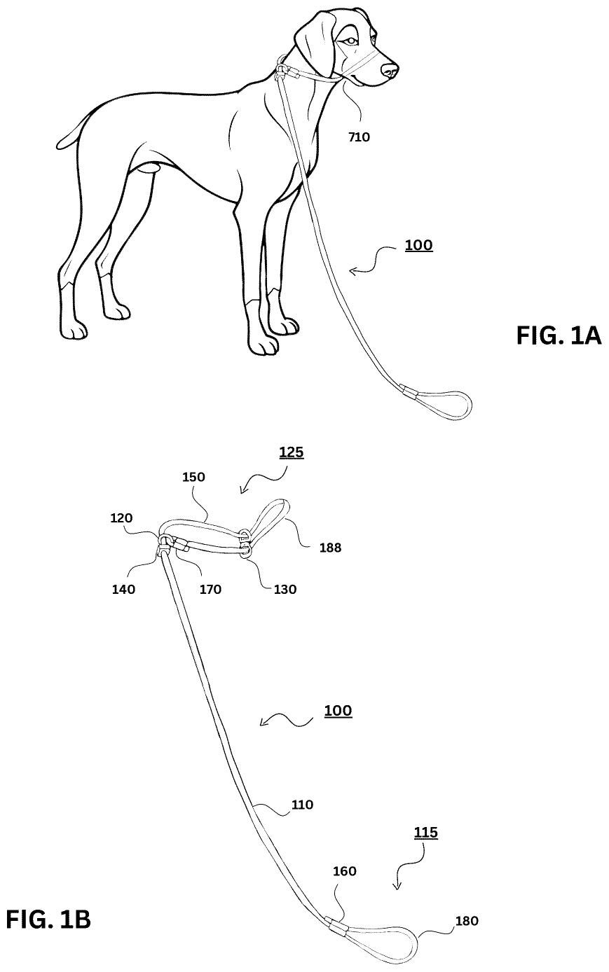

Referring to FIGS. 1AB, 3AB, 4AB, and 5AB, slip leash 100 comprises a flexible cord 110, that has a proximal end 115 and a distal end 125. The proximal end 115 loops around to form a handle 180 held by a dog handler. The distal end 125 comprises a connector 120, an anchor 130, and a cord lock 140 that can be configured to form multiple openings to fasten to a dog or other animal.

As described herein, the cord 110 refers to any material that has a suitable thickness, strength, flexibility, and length that can serve in the present invention, such as but not limited to; flat webbing, round webbing, rope, coated rope, leather, cotton, vinyl, rubber, or chain. In some instances, the cord 110 can be stitched, glued, pressed, knotted, stapled, weaved, wrapped, fused or crimped to attach the respective leash to itself in a permanent fashion. In some implementations, the chord 110 is composed, for example, of flat BioThane™ or round BioThane™.

As described herein, the sleeve component 170 can be composed of any metal that has a suitable thickness, strength, and size that can serve in the present invention, such as but not limited to; brass, steel, copper, aluminum, or metal alloy.

As described herein, the connector 120 can be composed of any material that has a suitable thickness, strength, and size that can serve in the present invention, such as but not limited to; metal, plastic, wood, rubber, vinyl, polytetrafluoroethylene (PTFE), or silicone. Further the connector 120 can take the form of any shape that is suitable to serve in the present invention, such as but not limited to; triangle, circle, square, oval, rectangle, pentagon, hexagon, octagon, heart, star, or diamond. In some implementations, the connector 120 is comprised, for example, of a carabiner, an O-ring, or a D-ring.

As described herein, the cord lock 140 can be composed of any material that has a suitable thickness, strength, shape, and size that can serve in the present invention, such as but not limited to; metal, plastic, wood, rubber, or vinyl in the shape of a cylinder, oval, circle, or square.

As described herein, the anchor 130 can be composed of any durable material that has a suitable thickness, strength, and size that can serve in the present invention, such as but not limited to; brass, stainless steel, copper, aluminum, metal alloy, rubber, plastic, or any other suitable material. The anchor 130 can be located anywhere along the cord 110 of any configuration of the present disclosure. In some implementations, the slip leash 100 can include any number of anchor components 130. In some cases the anchor 130 can have 2 or more openings.

FIGS. 1A and 1B illustrate an example of the snout loop configuration of the slip leash 100. At the distal end 125 of the slip leash 100, the cord 110 is threaded through the connector 120 to create a neck strap opening 150. The connector 120 should be capable of sliding freely across the cord 110 allowing custom adjustments to the size of the neck of the animal. In some implementations the cord 110 folds backwards into sleeve component 170 at the distal end 125 to enclose the connector 120. In some instances, sleeve component 170 is comprised of metal with a hollow core.

The cord 110 is also threaded through an anchor 130 to create the snout loop 188. The anchor 130 can slide to adjust to the size of the snout of the animal. In order to lock the snout loop 130, and neck strap 150 in place, cord lock 140 is affixed to the cord 110 adjacent to the connector 120.

The cord lock 140 is preferably spring-loaded so that the handler can squeeze the cord lock 140 and move it up or down along the cord 110 to secure the desired position of the neck strap 150, and ensure that the dog does not escape from the slip leash.

In some cases, in the snout loop configuration, the proximal end of the cord 115 is permanently pressed onto the cord 110 using the sleeve component 160 to create the handle 180 of slip leash 100. The handle 180 is used by the handler, leading or walking the dog, and can be customized to fit various size hands. Handle loop 180 can also optionally be made more comfortable by providing foam or other suitable padding.

In this snout loop configuration from FIGS. 1A and 1B, the handler has the ability to restrain the dog from pulling on the slip leash 100, to prevent jumping, and to stop the dog from reacting to environmental stimuli.

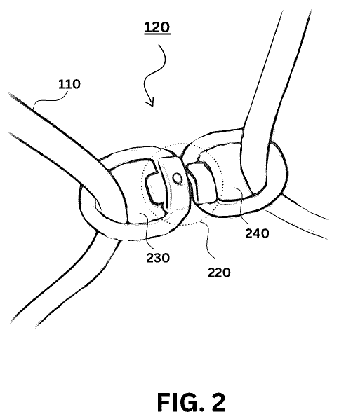

FIG. 2 depicts a close up view of the anchor 130 from the snout loop configuration (FIGS. 1A and 1B) of slip leash 100. In this example, the anchor 130 is made of solid brass with 2 adjoining rings on a swivel 220. In some implementations, the anchor 130 is comprised, for example, of a figure-8 ring with 2 apertures. A first aperture 230, and a second aperture 240 thread the cord 110 of slip leash 100. Preferably the anchor 130 is made of solid metal having a smooth surface that has a low coefficient of friction with the cord 110. This low frictional force between the anchor 130 and the cord 110 permits the anchor 130 to be easily moved by the handler, and slide up and down the slip leash 100 in all configurations (FIGS. 1AB, 3AB, 4AB, 5AB).

In the snout loop configuration in FIG. 1A above, the cord 110 is threaded through the anchor swivels 230 and 240, and fixed under a chin 710 of the dog. The swivel function 220 allows the dog's neck to extend, flex, rotate and laterally bend with ease. This prevents the dog from experiencing any pain or discomfort that may result from the use of certain embodiments of the prior art. This smooth thick metal also keeps the anchor 130 from being entangled in the chin hair of the dog.

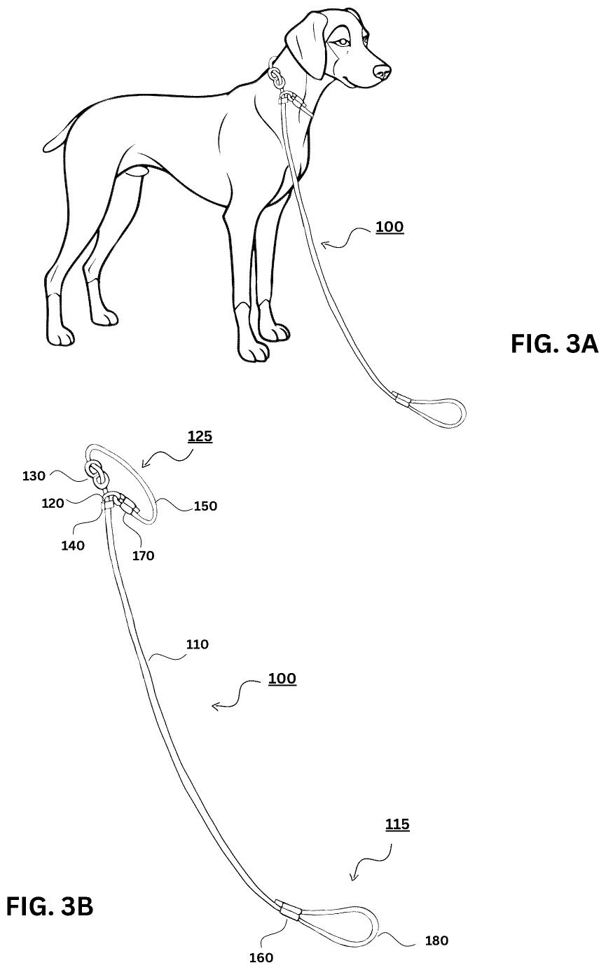

FIGS. 3A and 3B illustrate an example of the neck strap configuration of the slip leash 100. In some implementations the cord 110 folds backwards into sleeve component 170 to enclose the connector 120. The distal end 125 of the cord 110 is threaded through the connector 120 to create a neck strap 150. As in FIGS. 1A and 1B the connector 120 slides freely across slip leash 100 allowing custom adjustments to the size of the neck of the dog. In order to lock the neck strap 150 in place, cord lock 140 is affixed to the cord 110 adjacent to the connector 120. In some instances, the cord lock 140 is spring-loaded when suppressed by the handler for disengaging and re-engaging the cord lock 140. The cord lock 140 when used in this configuration is sometimes referred to as “the outside stopper”.

As shown in FIGS. 3A and 3B, after the cord lock 140 is positioned on the cord 110 for the selected size of the neck of the dog, the anchor 130 is slid into position on the opposite side of the connector 120. When the anchor 130 is fixed in place this will maintain its set size under tension on the leash. This mitigates the problem in prior art embodiments where there is no measure in place to prevent the dog from choking when pressure is applied and the slip leash 100 continues to movably constrict. The anchor 130 when used in this neck strap configuration 150, is sometimes referred to as “the inside stopper”.

In some cases, in the neck strap configuration, the proximal end of the cord 115 is permanently pressed onto the cord 110 using the sleeve component 160 to create the handle 180 of slip leash 100.

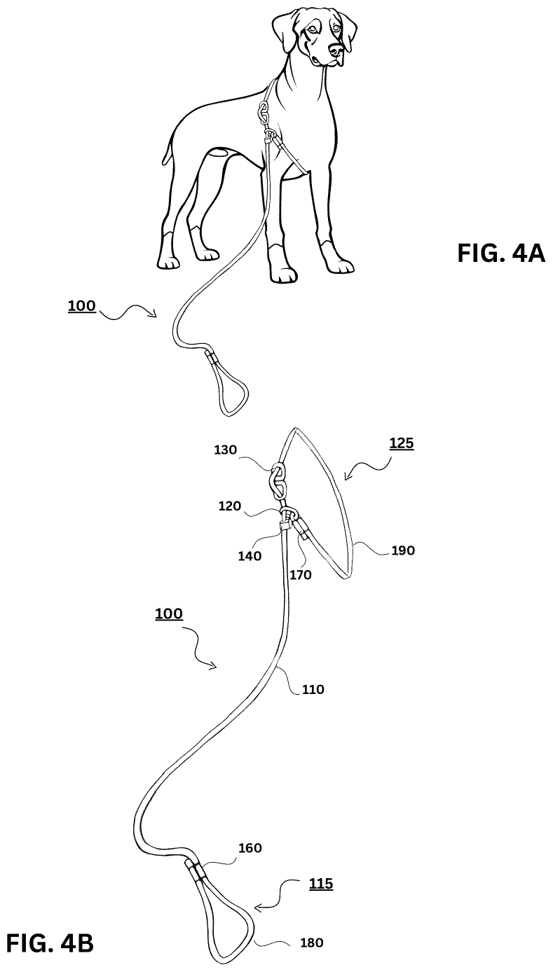

FIGS. 4A and 4B illustrate an example of the torso band configuration of the slip leash 100. In some instances the cord 110 folds backwards into sleeve component 170 to enclose the connector 120. The distal end 125 of the cord 110 is threaded through the connector 120 to create a torso band 190. As in FIGS. 1A ,1B, 3A, 3B, the connector 120 slides freely across the cord 110 allowing custom adjustments to the size of a torso of the dog 710. In order to lock the torso band 190 in place, cord lock 140 is affixed to the cord 110 adjacent to the connector 120. In some instances, the cord lock 140 is spring-loaded when suppressed by the handler for disengaging and re-engaging the cord lock 140.

As shown in FIGS. 4A and 4B, after the cord lock 140 is positioned on the cord 110 for the selected size of the torso of the dog 710, the anchor 130 is slid into position on the opposite side of the connector 120. When the anchor 130 is fixed in place this will maintain its set size under tension on the leash.

The torso band configuration 190, provides a practical solution for brachycephalic dogs such as, for example, French Bulldogs that are medically prone to chronic breathing problems. The torso band configuration 190 gives the handler the ability to secure the dog while walking without placing any pressure on the neck of the animal.

In some cases, in the torso band configuration, the proximal end of the cord 115 is permanently pressed onto the cord 110 using the sleeve component 160 to create the handle 180 of slip leash 100.

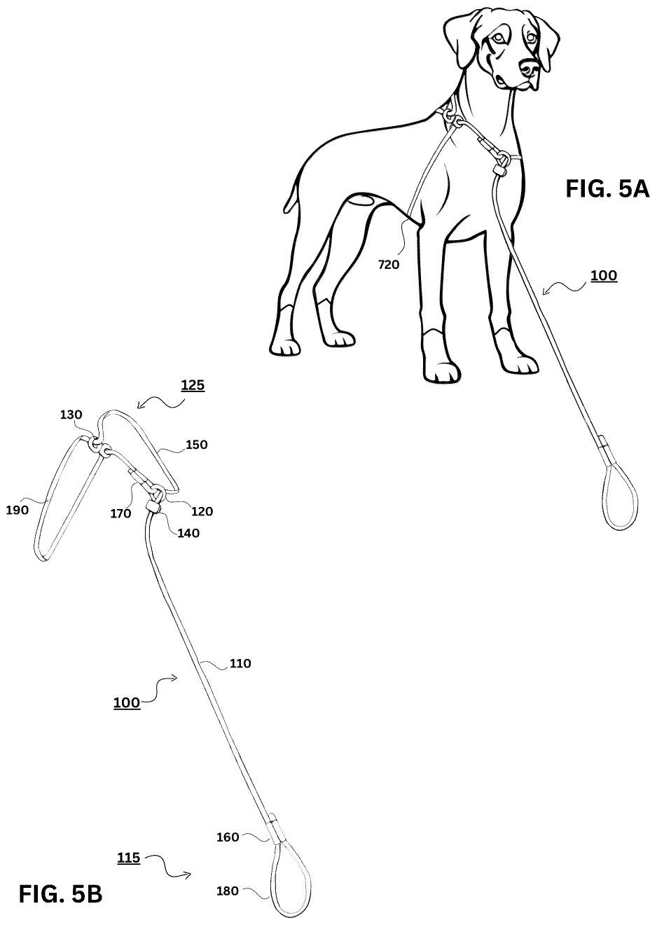

FIGS. 5A and 5B illustrate an example of a harness configuration of the slip leash 100. On the distal end 125, the cord 110 is threaded through the connector 120 to create the neck strap 150. The cord 110 continues to be threaded through the anchor 130 to create the torso band opening 190. The anchor 130 slides to adjust to the size of the torso of the dog and is used as an “inside stopper” as in previous embodiments. In some implementations, the cord 110 folds backwards into sleeve component 170 to enclose the connector 120.

Cord lock 140 is affixed to the cord 110 adjacent to connector 120 and functions as an “outside stopper” similar to the previous embodiments locking the position of the leash when released. The dog wears the torso band 190 anywhere around a dog torso body part 720 as seen in FIG. 5A.

In some cases, in the harness configuration, the proximal end of the cord 115 is permanently pressed onto the cord 110 using the sleeve component 160 to create the handle 180 of slip leash 100.

In this harness configuration from FIGS. 5A and 5B, the slip leash 100 allows for an exact contour fit to the dog's body in a form fitting harness. The harness configuration solves a problem for small dogs that are under 10 lbs. These “toy breeds” are often not able to find a harness system that fits their small body shape, and often slip out of loose fitting traditional harness systems. Where in this embodiment, the slidability of the anchor 130 combined with the cord lock 140 custom fits any size dog that can not escape.

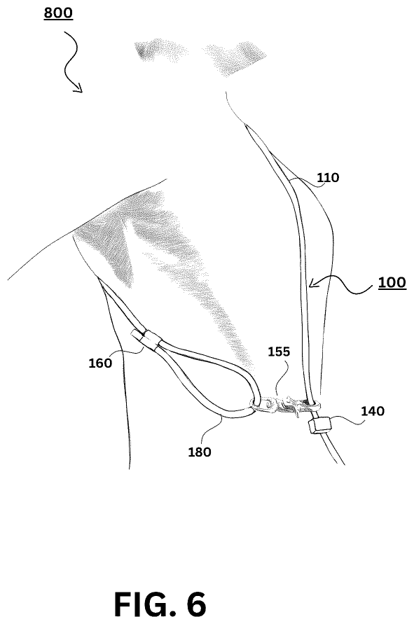

In some cases, as illustrated in FIG. 6, a snap hook 155 can be attached to the handle 180 that clips to the cord 110 of the slip leash 100. Preferably the snap hook 155 is of the type that can be selectively opened and closed for connection, and can be made of various suitable metals such as brass, copper, steel, or aluminum. In some instances, the handler 800, can wrap the slip leash 100 over the shoulder as in FIG. 6, or alternately as a waist-belt. The snap hook 155 is slidable along the cord 110 and can be adjusted to fit any size handler 800.

Cord lock 140 is fastened to the front of the handler's body to prevent the snap hook 155 from further sliding. In some cases, this configuration can allow the handler 800 a secure hands-free option while the dog remains tethered. In some instances, the snap hook 155 can be used to tether the dog to an indoor or outdoor structure by encircling, for example, a table leg, a fence post, or park bench. In some implementations, the snap hook 155 can be coupled to any configuration of slip leash 100 (e.g., FIGS. 1AB, 3AB, 4AB, 5AB) for a hands-free option.

The slip leash 100 can be used, for example, to support Accessibility Canada Act (ACA) and Americans with Disabilities Act (ADA) service dog handlers, dog show handlers, sport dog handlers, police dog handlers, therapy dog handlers, and dog trainers among others.

All publications, patents and patent applications mentioned in this specification are indicative of the level of skill of those skilled in the art to which this invention pertains and are herein incorporated by reference. The reference to any prior art in this specification is not, and should not be taken as, an acknowledgement or any form of suggestion that such prior art forms part of the common general knowledge.

The invention being thus described, it will be obvious that the same may be varied in many ways. Such variations are not to be regarded as a departure from the scope of the invention, and all such modifications as would be obvious to one are intended to be included within the scope of the following claims.

Various modifications will be readily apparent from the foregoing detailed description and the drawings. Accordingly, other implementations also are within the scope of the claims.

What is claimed is:

1. An animal slip leash comprising:
a cord;
a connector movable along the length of the cord;
a cord lock at the distal end of the cord; and
an anchor slidably coupled to the cord.

2. The slip leash of claim 1 wherein the cord comprises one or more of flat webbing, round webbing, rope, coated rope, leather, cotton, vinyl, rubber, or chain without being limited to these materials.

3. The slip leash of claim 1, further comprising a handle at the proximal end of the cord.

4. The slip leash of claim 1, wherein the handle is configured to vary in size, shape, or position relative to the cord.

5. The slip leash of claim 1, further comprising a snap hook that is movable along the cord, and configured to releasably engage the cord, enabling the leash to encircle a portion of the handler's body for a hands-free configuration.

6. The slip leash of claim 1 wherein the connector comprises a material such as but not limited to metal, plastic, wood, rubber, vinyl, polytetrafluoroethylene (PTFE), or silicone, and may take the form of a ring or carabiner or other shape.

7. The slip leash of claim 1, wherein the cord lock is spring-loaded and operable by the handler to temporarily disengage and re-engage the cord lock to allow adjustment of the cord.

8. The slip leash of any one of claims 1-7, wherein the anchor is adjustable along the length of the cord to allow a custom fit around a selected region of the animal's body, such as the neck, snout, or torso.

9. The slip leash of any one of claims 1-8, wherein the anchor comprises a swivel.

10. The slip leash of any one of claims 1-9, wherein the anchor comprises at least 2 adjacent apertures that receive and guide the cord.

11. The slip leash of any one of claims 1-10, wherein the anchor comprises a smooth surface that has a low coefficient of friction with the cord.

12. The slip leash of any one of claims 1-11, wherein the anchor includes a solid, continuous frame enclosing the apertures.

13. The slip leash of any one of claims 1-12, wherein the anchor is non-swiveling and comprises a metallic or non-metallic material.

14. A method of training an animal comprising attaching a slip leash to an animal, the slip leash comprising:
a cord;
a connector movable along the length of the cord;
a cord lock at the distal end of the cord; and
an anchor positioned at the chin of the animal, the anchor comprising at least two apertures for receiving the cord, sliding the anchor to form a snout loop opening encircling the animal's snout, and to form a neck strap opening to encircle the animal's neck, affixing the cord lock at the top of the animal's neck between the ears; and reducing the diameter of the neck strap thereby securing the animal in the slip leash.

15. The method of claim 14, wherein when walking with the handler, when the animal moves forward and exerts a pulling motion on the slip leash, the handler applies pressure to the slip leash to control the animal and retain the animals attention.

16. The method of any one of claims 14-15, wherein the applied pressure is in the form of steady tension, or a sharp popping motion.

17. The method of any one of claims 14-16, wherein the handler changes directions when walking while continuing to apply the pressure, until the animal is in a following state.

18. The method of any one of claims 14-17, further comprising issuing a verbal command or hand signal to the animal.

19. The method of any one of claims 14-18, wherein the animal is a dog.

20. The method of any one of claims 14-19, wherein the animal is being trained to stop pulling on the leash.
